(19) United States
(12) Patent Application Publication
(10) Pub. No.: US 2026/0300665 A1
(43) Pub. Date: Oct. 1, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: MASAYUKI YAMADA, Kanagawa (JP)

(21) Appl. No.: 19/574,061

(22) Filed: Mar. 20, 2026

(30) Foreign Application Priority Data
Mar. 25, 2025 (JP) 2025-050806

(51) Int. Cl. G06K 15/00; G03G 15/00

(52) U.S. Cl. CPC G06K 15/4065; G03G 15/5016; G03G 15/5095; G06K 15/002; G03G 2215/00734

(57) ABSTRACT

In a case where a selection result of a size group is a first size group and a candidate of a detected sheet size includes a first size and a second size, based on acquired information regarding a utilization site, being information regarding a first site, an information processing apparatus determines a sheet size to be the first sheet size, and based on acquired information regarding a utilization site, being information regarding a second site different from the first site, the information processing apparatus determines does not determine a sheet size to be a specific sheet size.

### BACKGROUND

### Field of the Technology

The present embodiment relates to an information processing apparatus, a control method, and a storage medium.

### Description of the Related Art

There has been known an image processing apparatus that reads and digitizes characters or images described in a document, or records characters or image data on a sheet. Sizes of sheets to be used for the recording in an image processing apparatus include various types such as sheet sizes defined by the International Standard or standards of countries or regions, conventionally-used sheet sizes, or the like. A user needs to appropriately change the setting of the image processing apparatus in accordance with a sheet size desired to be used.

Japanese Patent Laid-Open No. 2015-139931 describes an image forming apparatus that includes a mechanism for detecting a sheet size that is provided on a sheet stacking portion on which a plurality of sheets can be stacked, and detects a sheet size of a sheet stacked on the sheet stacking portion. Furthermore, in the image processing apparatus described in Japanese Patent Laid-Open No. 2015-139931, it is described that an image forming operation is not performed in a case where a detected sheet size is a set other than a set size.

On the other hand, in an information processing apparatus that performs processing using sheets, such as an image processing apparatus, various types of sheets are used, and some sizes are indistinguishable by a sheet size detection mechanism of the information processing apparatus.

### SUMMARY

In view of the foregoing, the present disclosure is directed to enabling easy setting of a sheet size (size of sheets) indistinguishable by a sheet size detection mechanism, in an information processing apparatus.

According to an aspect of the present disclosure, an information processing apparatus configured to execute predetermined processing on a sheet with a first size or a second sheet with a second size different from the first size includes an acquisition unit configured to acquire information regarding a utilization site of the information processing apparatus, a first selection unit configured to select any of a plurality of size groups including a first size group including the first size, and a second size group including the second size, a detection unit configured to detect a candidate of a size of a sheet on which the predetermined processing is to be executed, a determination unit configured to determine, based on a selection result obtained by the selection unit and a candidate of a sheet size detected by the detection unit, a size of a sheet on which the predetermined processing is to be executed, and a processing unit configured to execute the predetermined processing based on the determined size of the sheet, wherein, in a case where the selection result is the first size group and a candidate of a sheet size detected by the detection unit includes the first size and the second size, the determination unit determines, based on information regarding a utilization site that has been acquired by the acquisition unit, being information regarding a first site, a sheet size to be the first sheet size, and wherein based on information regarding a utilization site that has been acquired by the acquisition unit, being information regarding a second site different from the first site, the determination unit does not determine a sheet size to be a specific sheet size.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an image processing apparatus according to a first embodiment.

FIGS. 2A and 2B are an external view and a cross-sectional view of the image processing apparatus according to the first embodiment.

FIGS. 3A to 3C are schematic diagrams of a manual feed tray according to the first embodiment.

FIGS. 4A to 4C are schematic diagrams of a sheet drawer according to the first embodiment.

FIGS. 5A and 5B are schematic diagrams of a reading unit and an operation unit according to the first embodiment.

FIG. 6 is a block diagram illustrating an example of functions of the image processing apparatus according to the first embodiment.

FIGS. 7A and 7B are diagrams each illustrating an example of a screen of a copy application according to the first embodiment.

FIG. 8 is a diagram illustrating an example of data related to a destination that is to be held in the image processing apparatus according to the first embodiment.

FIGS. 9A and 9B are diagrams each illustrating an example of a setting screen of the image processing apparatus according to the first embodiment.

FIG. 10 is a diagram illustrating an example of a setting screen of the image processing apparatus according to the first embodiment.

FIGS. 11A and 11B are diagrams each illustrating an example of a setting screen of the image processing apparatus according to the first embodiment.

FIG. 12 is a flowchart illustrating processing to be executed by the image processing apparatus according to the first embodiment.

FIG. 13 is a flowchart illustrating subroutine processing of detecting a sheet size according to the first embodiment.

FIG. 14 is a flowchart illustrating initialization processing of an image processing apparatus according to other embodiments.

FIG. 15 is a diagram illustrating an example of an error screen according to other embodiments.

### DESCRIPTION OF THE EMBODIMENTS

Hereinafter, the present disclosure will be described in detail with reference to the drawings. The following embodiments are not intended to limit the present disclosure set forth in the appended claims, and not all combinations of features described in the present embodiment are always essential to the solution of the present disclosure. In addition, in the accompanying drawings, the same or similar components are assigned the same reference numerals, and the redundant description will be omitted.

### First Embodiment

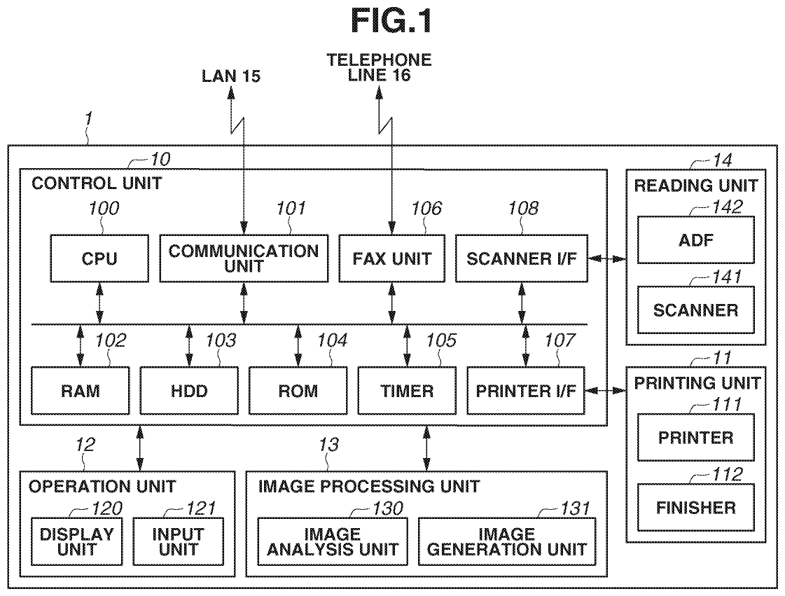

FIG. 1 is a block diagram illustrating a configuration of an image processing apparatus 1 serving as an example of an information processing apparatus according to the present embodiment. The image processing apparatus 1 is a printer of a multifunction peripheral (MFP) having the following functions, for example. The image processing apparatus 1 may be a printer of a single function peripheral (SFP) instead of the MFP. In addition, a recording method (printing method) of the image processing apparatus 1 may be an electrophotographic method or an inkjet method, or may be another method. In addition, the image processing apparatus 1 need not be a printer, and may be a scanner or a facsimile. Furthermore, the information processing apparatus according to the present embodiment need not be an image processing apparatus, and the present embodiment can be widely applied to an information processing apparatus that handles sheets.

The image processing apparatus 1 includes a control unit 10, an operation unit 12, an image processing unit 13, a reading unit 14, and a printing unit 11. The control unit 10 performs the operation control of each unit of the image processing apparatus 1. The control unit 10 includes a central processing unit (CPU) 100, a communication unit 101, a random access memory (RAM) 102, a hard disk drive (HDD) 103, a read-only memory (ROM) 104, a timer 105, a FAX unit 106, a scanner interface (I/F) 108, and a printer I/F 107.

The CPU 100 controls the entire image processing apparatus 1. The RAM 102 functions as a work memory of the CPU 100. The HDD 103 stores application programs and image data. The HDD 103 may be a storage medium such as an optical medium, flash memory, or a solid state drive (SSD). The ROM 104 stores programs and data such as boot programs that are to be read out by the CPU 100. In addition, the HDD 103 may be detachably attached to the image processing apparatus 1 as an external storage device. The timer 105 manages time, is referred to by the CPU 100, and allows the CPU 100 to acquire time information.

In the image processing apparatus 1, the CPU 100 may have a multiprocessor configuration. In a case where the CPU 100 has a multiprocessor configuration, each processor takes charge of a part of processing to be described below, and implements the entire processing by cooperation between processors. Each processor may employ a symmetric configuration, or may employ a configuration specialized for each function, such as a configuration for an image processing unit and a configuration for a printing unit.

The communication unit 101 is connected to a local area network (LAN) 15, and controls data transmission and reception to be performed via the LAN 15. The FAX unit 106 is connected to a telephone line 16, and controls data transmission and reception to be performed via the telephone line 16. The operation unit 12 includes a display unit 120 and an input unit 121, and displays a screen and receives operations from the user. In the present embodiment, a liquid crystal display will be described as an example of the display unit 120, but a display of another technology may be used. In the present embodiment, a touch panel attached to the display unit 120 will be described as an example of the input unit 121, but a mouse or hardware keys may be used.

The image processing unit 13 is controlled by the control unit 10, and includes an image analysis unit 130 and an image generation unit 131. The image analysis unit 130 analyzes a structure of a document image, and extracts necessary information from an analysis result. The image generation unit 131 generates image data by digitalizing a document image read by a scanner 141. The generated image data is stored into the HDD 103. In addition, the image generation unit 131 generates an image based on data acquired via the communication unit 101. Furthermore, the image generation unit 131 generates document image data of another format using information analyzed by the image analysis unit 130.

The reading unit 14 includes the scanner 141 and an automatic document feeder (ADF) 142. A document placed on the ADF 142 is conveyed to the scanner 141, and a document image is read. The printing unit 11 includes a printer 111 and a finisher 112. Image data transferred from the control unit 10 to the printing unit 11 via the printer I/F is printed on a sheet by the printer 111. The finisher 112 performs postprocessing such as sorting and stapling processing of printed sheets.

The image processing apparatus 1 has a copy function, a scan function, and a print function. The copy function is a function of reading image data of a document by the scanner 141, and printing an image that is based on the read image data of the document, on a sheet by the printing unit 11. The scan function is a function of transmitting, by the communication unit 101, image data generated by reading an image in a document by the scanner 141. The print function is a function of printing an image that is based on print data received from an information processing apparatus such as an external personal computer (PC) via the communication unit 101, onto a sheet by the printing unit 11.

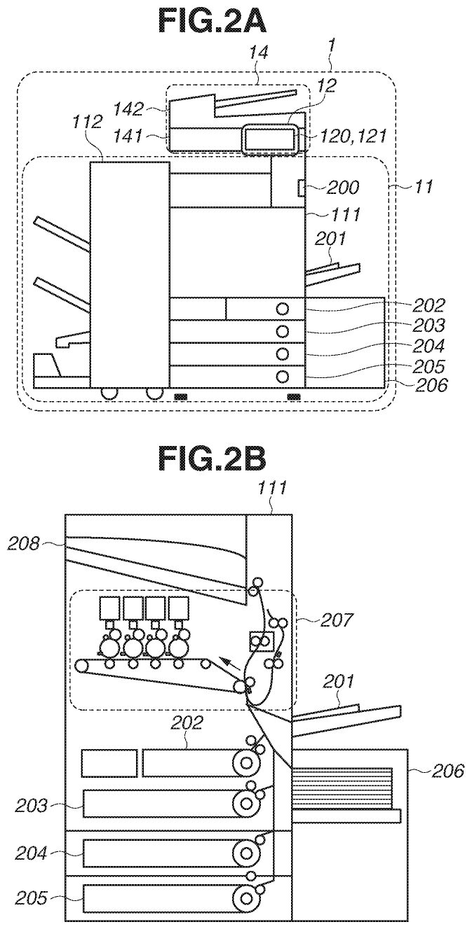

FIGS. 2A and 2B are an external view of the image processing apparatus 1 according to the present embodiment, and a cross-sectional view of the printer 111. In FIG. 2A, portions (1, 11, 14) surrounded by dotted lines respectively indicate the entire image processing apparatus 1, the printing unit 11, and the reading unit 14. In the operation unit 12, a liquid crystal panel is arranged as the display unit 120, and a touch panel is arranged thereon as the input unit 121. A main power switch 200 is a main power switch of the image processing apparatus 1.

In FIGS. 2A and 2B, the image processing apparatus 1 includes a manual feed tray 201. The image processing apparatus 1 includes sheet drawers 202 to 205. The image processing apparatus 1 includes a sheet feeding deck 206. The image processing apparatus 1 includes a printer engine 207, and a sheet discharge unit 208. Among the sheet drawers 202 to 205, only the sheet drawer 202 is small in size. Thus, only sheets with sizes up to a letter size can be placed therein. The sheet feeding deck 206 does not have a mechanism of detecting a sheet size of a placed sheet. Sheets placed on the manual feed tray 201, the sheet drawers 202 to 205, and the sheet feeding deck 206 are conveyed to the printer engine 207, and images are formed onto the sheets by the printer engine 207. The sheets on which images are formed are conveyed to the finisher 112 through the sheet discharge unit 208.

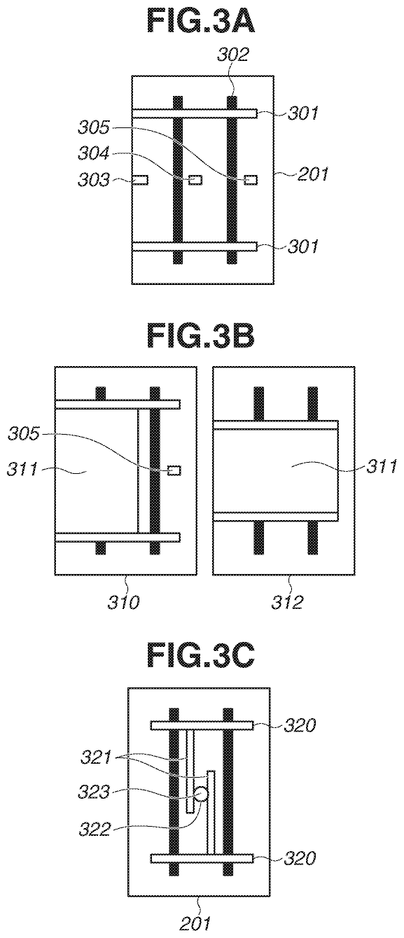

FIGS. 3A to 3C are diagrams schematically illustrating the manual feed tray 201 according to the present embodiment. FIG. 3A illustrates a configuration of the manual feed tray 201 viewed from above. In the manual feed tray 201, a guide 301 freely movable on a rail 302 is provided. The position of the guide 301 can be adjusted in accordance with a width of a sheet to be set. Sensors 303, 304, and 305 detect that a sheet is placed. If a sheet is placed on the sensors, the CPU 100 can detect that a sheet has been set in the manual feed tray 201.

In FIG. 3B, a diagram 310 is a diagram illustrating a position of the guide 301 that is set in a case where a sheet 311 is set in portrait orientation, and a diagram 312 is a diagram illustrating a position of the guide 301 that is set in a case where the sheet 311 is set in landscape orientation. As illustrated in FIG. 3B, the position of the guide 301 varies depending on the orientation in which the sheet 311 is placed. Hereinafter, a sheet size to be detected depending on the position of the guide 301 of the manual feed tray 201 will be referred to as a width. In addition, in the diagram 310, while the sensors 303 and 304 detect the sheet 311, the sensor 305 does not detect the sheet 311. On the other hand, in the diagram 312, all of the sensors 303, 304, and 305 detect the sheet 311. Hereinafter, a sheet size (sheet size) to be detected by the sensors 303, 304, and 305 of the manual feed tray 201 will be referred to as a length.

FIG. 3C illustrates a configuration of the manual feed tray 201 viewed from below. A component 320 is fixed to the guide 301 across the rail 302. Furthermore, a component 321 is fixed to the component 320, and moves in accordance with the movements of the guide 301 and the component 320. A rotatable member 322 constitutes a rack-and-pinion structure together with the component 321, and rotates in accordance with the movement of the component 321. Furthermore, the rotatable member 322 is provided with a rotational angle sensor 323, and a rotational angle of the rotatable member 322 can be measured. By measuring the rotational angle of the rotatable member 322, it is possible to measure an opening width of the guide 301. An output of the rotational angle sensor 323 is detected via an analog-to-digital (A/D) converter by the CPU 100 as a numerical value.

TABLE 1
correspondence relationship between sheet sizes and
detected values of sensors 303, 304, 305, and 323

| | | Sheet | Sheet | Length detection | | | Width detection | |
|---|---|---|---|---|---|---|---|---|
| | | length | width | Sensor | Sensor | Sensor | Sensor 323 | |
| | Size | (mm) | (mm) | 303 | 304 | 305 | output | Group |
| A-series | A3 | 420 | 297 | ON | ON | ON | 0x358 ± 0x10 | A |
| | A4 | 210 | 297 | ON | ON | OFF | 0x358 ± 0x10 | |
| | A4R | 297 | 210 | ON | ON | OFF | 0x203 ± 0x10 | B |
| | A5 | 148 | 210 | ON | OFF | OFF | 0x203 ± 0x10 | |
| | A5R | 210 | 148 | ON | ON | OFF | 0x111 ± 0x10 | C |
| | A6R | 148 | 105 | ON | OFF | OFF | 0x069 ± 0x10 | |
| B-series | B4 | 364 | 257 | ON | ON | ON | 0x2bb ± 0x10 | |
| | B5 | 182 | 257 | ON | ON | OFF | 0x2bb ± 0x10 | |
| | B5R | 257 | 182 | ON | ON | OFF | 0x196 ± 0x10 | |
| Inch- [symbol] | 12 × 18 | 457.2 | 304.8 | ON | ON | ON | 0x376 ± 0x10 | A |
| | 11 × 17 | 431.8 | 279.4 | ON | ON | ON | 0x313 ± 0x10 | |
| | LTR | 215.9 | 279.4 | ON | ON | OFF | 0x313 ± 0x10 | |
| | EXEC | 184.1 | 266.7 | ON | ON | OFF | 0x2e1 ± 0x10 | D |
| | LGL | 355.6 | 215.9 | ON | ON | ON | 0x21a ± 0x10 | E |
| | LTRR | 279.4 | 215.9 | ON | ON | OFF | 0x21a ± 0x10 | B |
| | STMTR | 215.9 | 139.7 | ON | ON | OFF | 0x0f1 ± 0x10 | C |
| Local | I-LGL | 345 | 215 | ON | ON | ON | 0x217 ± 0x10 | E |
| size | 8K | 390 | 270 | ON | ON | ON | 0x2ee ± 0x10 | |
| | 16K | 195 | 270 | ON | ON | OFF | 0x2ee ± 0x10 | D |
| | 16KR | 270 | 195 | ON | ON | OFF | 0x1c9 ± 0x10 | |

[symbol]

indicates data missing or illegible when filed

Table 1 is a table showing a correspondence relationship between sheet sizes and detected values of the sensors 303, 304, 305, and 323. The values in Table 1 are held in the RAM 102 or the ROM 104. In Table 1, LTR, LGL, and STMT respectively indicate letter, legal, and statement sizes. I-LGL indicates a legal size mainly used in India. A4R, A5R, A6R, B5R, LTRR, STMTR, and 16KR respectively indicate sizes obtained by rotating A4, A5, A6, B5, LTR, STMT, and 16K sizes by 90 degrees. In Table 1, in a case where the sensors 303, 304, and 305 detect a sheet, “ON” is described, and in a case where the sensors 303, 304, and 305 do not detect any sheet, “OFF” is described. An output value of the sensor 323 is represented by a hexadecimal number. Because an output value of the sensor 323 includes an error, the correspondence between a detected value and a detection result has a tolerance of ±0x10. For example, in a case where detection results of the sensors 303 and 304 indicate ON, a detection result of the sensor 305 indicates OFF, and an output value of the sensor 323 falls within the range from 0x348 to 0x368, a size of a sheet placed on the manual feed tray 201 is determined to be an A4 size.

On the other hand, in some cases, a sheet size cannot be uniquely defined based on detection results of the sensors 303, 304, 305, and 323. More specifically, it is impossible to distinguish between sheet sizes for which the combinations of detection results of the sensors 303, 304, 305, and 323 can be the same. For example, in a case where detection results of the sensors 303, 304, and 305 all indicate ON, and an output value of the sensor 323 ranges from 0x366 to 0x368, it is impossible to distinguish between A3 and 12×18. In this manner, sheet sizes for which detection results of the sensors 303, 304, and 305 are the same, and output values of the sensor 323 have an overlap are labeled in a “group” column in Table 1. Sheet sizes for which the same letter is described in the “group” column sometimes fail to be determined based on the detection results of the sensors 303, 304, 305, and 323.

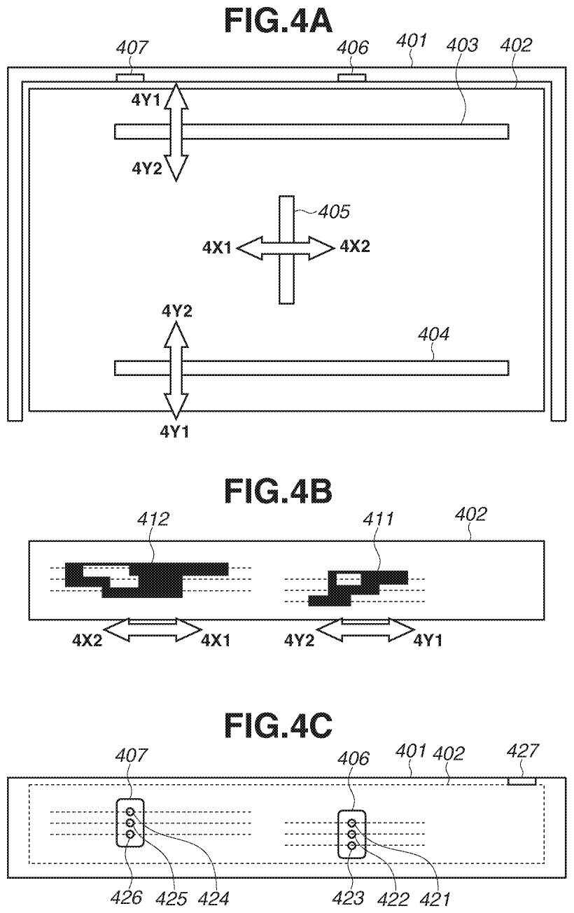

FIGS. 4A to 4C are diagrams schematically illustrating the sheet drawers 202 to 205 according to the present embodiment. FIG. 4A illustrates a configuration of the sheet drawers 202 to 205 viewed from above. In FIG. 4A, a casing portion 401 is a casing portion that holds the sheet drawers 202 to 205. A cassette main body 402 is a cassette main body of the sheet drawers 202 to 205. Guides 403 and 404 are guides attached to the cassette main body 402. The guides 403 and 404 have a link mechanism similar to that of the guide 301, and move in a direction indicated by an arrow 4Y1 or 4Y2, in accordance with a sheet size. A guide 405 is a guide similarly attached to the cassette main body 402.

The guide 405 moves in a direction indicated by an arrow 4X1 or 4X2, in accordance with a sheet size. Hereinafter, a sheet size to be measured based on an interval between the guides 403 and 404 will be referred to as a width, and a sheet size to be measured based on a movement amount of the guide 405 will be referred to as a length. Triple switches 406 and 407 are triple switches attached to the casing portion 401. The details of the triple switches 406 and 407 will be described below.

FIG. 4B is a diagram illustrating a configuration of the cassette main body 402 viewed from the lateral side. In FIG. 4B, a sheet width detection plate 411 is attached to the lateral side of the cassette main body 402. The sheet width detection plate 411 is connected with the guides 403 and 404 by a link mechanism (not illustrated), and moves leftward and rightward in accordance with the movements of the guides 403 and 404. If the guides 403 and 404 move in a direction indicated by the arrow 4Y1, the sheet width detection plate 411 also moves in the 4Y1 direction by a distance proportional to the movement amounts of the guides 403 and 404. Similarly, if the guides 403 and 404 move in a direction indicated by the arrow 4Y2, the sheet width detection plate 411 also moves in the 4Y2 direction.

A sheet length detection plate 412 is attached to the lateral side of the cassette main body 402. The sheet length detection plate 412 is connected with the guide 405 by a link mechanism (not illustrated), and moves leftward and rightward in accordance with the movement of the guide 405. If the guide 405 moves in a direction indicated by an arrow 4X1, the sheet length detection plate 412 also moves in the 4X1 direction by a distance proportional to the movement amount of the guide 405. Similarly, if the guide 405 moves in a direction indicated by an arrow 4X2, the sheet length detection plate 412 also moves in the 4X2 direction.

FIG. 4C is a side view illustrating the triple switches 406 and 407 attached to the casing portion 401. In FIG. 4C, switches 421, 422, and 423 are included in the triple switch 406. The triple switch 406 is attached at a height aligned with the sheet width detection plate 411, and detection results of the switches 421, 422, and 423 indicate ON if the switches 421, 422, and 423 have contact with a black portion of the sheet width detection plate 411. In a case where the black portion of the sheet width detection plate 411 does not exist at the positions of the switches 421, 422, and 423, detection results of the switches 421, 422, and 423 indicate OFF.

Similarly, switches 424, 425, and 426 output ON or OFF in accordance with the position of the sheet length detection plate 412. In addition, the switches 421 to 426 function also as an insertion detection sensor of the cassette main body 402. In a case where any of the switches 421 to 426 outputs ON, it is determined that the cassette main body 402 has been inserted into the casing portion 401. A sensor 427 detects the presence or absence of a sheet in the cassette main body 402. An output of each sensor is detected by the CPU 100.

TABLE 2
correspondence relationship between sheet sizes and detected values of sensors 421 to 426

| | | Sheet | Sheet | Length detection | | | Width detection | | | |
|---|---|---|---|---|---|---|---|---|---|---|
| | | length | width | Sensor | Sensor | Sensor | Sensor | Sensor | Sensor | |
| | Size | (mm) | (mm) | 424 | 425 | 426 | 421 | 422 | 423 | Group |
| A-series | A3 | 420 | 297 | ON | ON | OFF | OFF | OFF | ON | |
| | A4 | 210 | 297 | ON | ON | ON | OFF | OFF | ON | |
| | A4R | 297 | 210 | OFF | ON | ON | ON | ON | OFF | |
| | A5 | 148 | 210 | ON | OFF | OFF | ON | ON | OFF | |
| | A5R | 210 | 148 | ON | ON | ON | ON | OFF | OFF | C |
| | A6R | 148 | 105 | ON | OFF | OFF | ON | OFF | OFF | |
| B-series | B4 | 364 | 257 | OFF | ON | OFF | OFF | ON | OFF | |
| | B5 | 182 | 257 | ON | OFF | OFF | OFF | ON | OFF | |
| | B5R | 257 | 182 | ON | OFF | ON | ON | OFF | OFF | |
| Inch-series | 12 × 18 | 457.2 | 304.8 | OFF | OFF | OFF | OFF | OFF | ON | |
| | 11 × 17 | 431.8 | 279.4 | OFF | OFF | OFF | ON | ON | ON | |
| | LTR | 215.9 | 279.4 | ON | ON | ON | ON | ON | ON | |
| | EXEC | 184.1 | 266.7 | ON | OFF | OFF | OFF | ON | ON | |
| | LGL | 355.6 | 215.9 | OFF | ON | OFF | ON | ON | OFF | E |
| | LTRR | 279.4 | 215.9 | OFF | OFF | ON | ON | ON | OFF | |
| | STMTR | 215.9 | 139.7 | ON | ON | ON | ON | OFF | OFF | C |
| Local | I-LGL | 345 | 215 | OFF | ON | OFF | ON | ON | OFF | E |
| size | 8K | 390 | 270 | ON | ON | OFF | OFF | ON | ON | |
| | 16K | 195 | 270 | ON | ON | ON | OFF | ON | ON | |
| | 16KR | 270 | 195 | OFF | OFF | ON | ON | OFF | OFF | |

Table 2 is a table showing a correspondence relationship between sheet sizes and detected values of the sensors 421 to 426. The values in Table 2 are held in the RAM 102 or the ROM 104. In Table 2, in a case where each sensor detects a sheet detection plate, “ON” is described, and in a case where each sensor does not detect a sheet detection plate, “OFF” is described. For example, in a case where output values of the sensors 421 and 422 indicate OFF, and output values of the sensors 423 to 426 indicate ON, a size of a sheet placed in the cassette main body 402 is determined to be the A4 size. On the other hand, in some cases, a sheet size cannot be uniquely defined based on detection results of the sensors 421 to 426. More specifically, it is impossible to distinguish between sheet sizes for which the combinations of detection results of the sensors 421 to 426 can be the same. For example, in a case where detection results of the sensors 422 and 423 indicate OFF, and detection results of the other sensors indicate ON, A5R and STMTR both serve as candidates, and it is impossible to distinguish between these. In this manner, sheet sizes for which detection results of the sensors 421 to 426 are the same are labeled in a “group” column in Table 2. It is impossible to distinguish between sheet sizes for which the same letter is described in the “group” column, based on the detection results of the sensors 421 to 426.

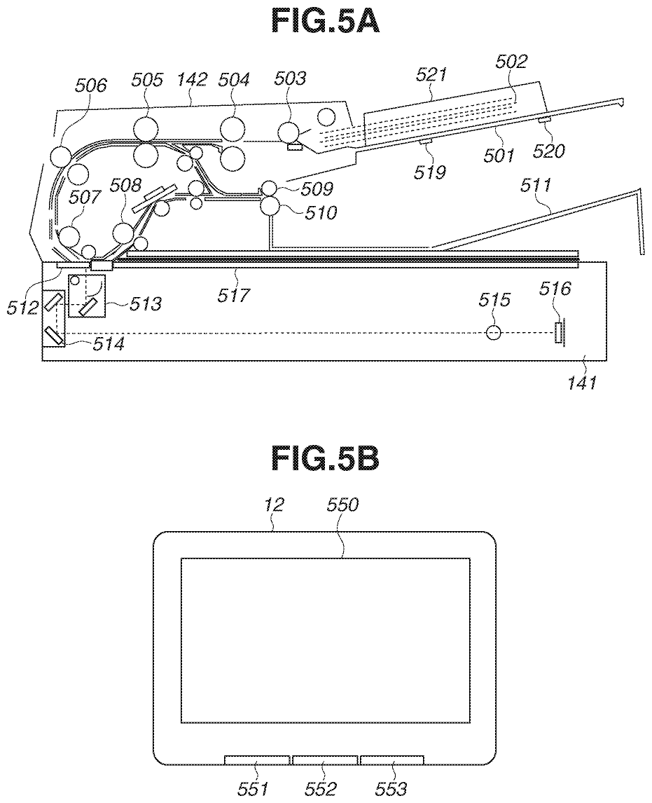

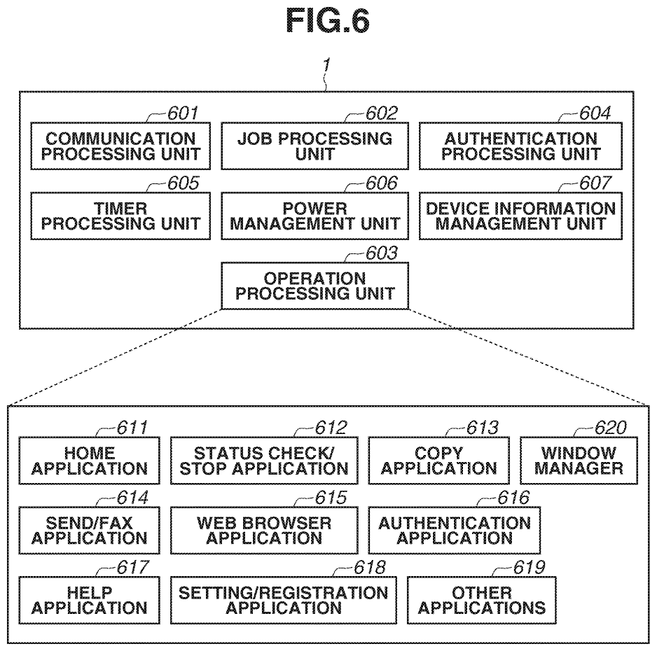

FIGS. 5A and 5B are schematic diagrams illustrating a reading unit and an operation unit according to the first embodiment. FIG. 5A is a cross-sectional view of the reading unit 14. A document 502 placed on a document tray 501 of the ADF 142 is conveyed by conveyance rollers 503 to 510, and discharged to a tray 511. During this process, an image on the document 502 is read by a sensor 516 through optical systems 512 to 515. In addition, by moving a movable member 513, it is possible to read a sheet-like image placed on a document platen 517. The ADF 142 is provided with sensors (518, 519, and 520) similar to the sensors 303 to 304 on the manual feed tray 201. Furthermore, a document guide 521 of the ADF 142 is provided with a sensor (not illustrated) similar to the sensor 323 of the manual feed tray 201.

FIG. 5B is an external view of the operation unit 12 in FIG. 1. A touch panel 550 has a configuration in which a touch panel sheet is attached onto a liquid crystal display. On the liquid crystal display, an operation screen and an object such as software keys are displayed. If a displayed object is selected by an instruction member (for example, a finger of the user), the touch panel sheet detects this, and notifies the CPU 100 of position information about the selected object. The CPU 100 can thereby determine an object selected by the user. That is, the touch panel 550 functions as the display unit 120 in FIG. 1, and functions also as the input unit 121. In FIG. 5B, a light-emitting diode (LED) 551 is an LED indicating that processing is in execution, an LED 552 is an LED indicating that an error has occurred, and an LED 553 is an LED indicating a power state.

FIG. 6 is a block diagram illustrating an example of functions of the image processing apparatus 1 illustrated in FIG. 1. The image processing apparatus 1 includes, as its functions, a communication processing unit 601, a job processing unit 602, and an operation processing unit 603. In addition, the image processing apparatus 1 further includes an authentication processing unit 604, a timer processing unit 605, a power management unit 606, and a device information management unit 607. These functional units are functions to be implemented by the CPU 100 (FIG. 1) loading programs stored in the ROM 104 or the HDD 103, onto the RAM 102, and executing the programs.

The communication processing unit 601 controls the communication unit 101 and the FAX unit 106, and executes analysis and communication control of communicated information transmitted to and received from an external device (not illustrated) connected via the LAN 15 or the telephone line 16. The job processing unit 602 performs processing of various jobs to be executed by the image processing apparatus 1. Specifically, the job processing unit 602 executes a print job by controlling the printing unit 11, executes a scan job by controlling the scanner 141, and executes a transmission job via the communication processing unit 601. In addition, the job processing unit 602 performs control of stop processing and cancel processing of the above-described various jobs.

The operation processing unit 603 displays various types of information for the user on the display unit 120 (the touch panel 550). Furthermore, the operation processing unit 603 processes an operation instruction entered by the user from the input unit 121 (the touch panel 550 and hardware keys (not illustrated)). The authentication processing unit 604 receives a login/logout request from the user, and performs authentication processing and processing of managing a user who uses the image processing apparatus 1.

The timer processing unit 605 provides the operation processing unit 603 and other processing units with a function to be executed using the timer 105. The power management unit 606 manages a power state of this apparatus. The device information management unit 607 holds and manages information such as a model type name, a destination, and a language of the image processing apparatus 1.

The operation processing unit 603 includes applications (611 to 619) for providing the user with functions to be executed using the image processing apparatus 1. Each application provides the user with a function independently or in cooperation with another application. A home application 611 is used to present a list of applications usable in the image processing apparatus 1, to the user, and display an application selected by the user. A status check/stop application 612 is used to display an execution status of a job, and stop an ongoing job.

A copy application 613 is used to implement a copy function of outputting an image read by the scanner 141, from the printing unit 11. A send/FAX application 614 is used to implement a send/FAX function of transmitting an image read by the scanner 141, through the communication unit 101 or the FAX unit 106. A web browser application 615 is used to display, on the display unit 120, content acquired from a web server (not illustrated) inside or outside the device through the communication unit 101, and transmit a form to the web server.

An authentication application 616 is used to authenticate the user using the authentication processing unit 604, and cause the user to log into the image processing apparatus 1. A help application 617 is used to provide information that assists an operation when the user has a trouble in an operation. A setting/registration application 618 is used to change the setting of the image processing apparatus 1, and register device information and user information. Aside from these, a plurality of applications (619) exists for the respective functions to be provided to the user. Other applications 619 include not only applications installed on the image processing apparatus 1 at the time of factory shipment, but also applications installed through the LAN 15 and the HDD 103.

The operation processing unit 603 further includes a window manager 620. The window manager 620 controls a display state of the applications 611 to 619 on the display unit 120. In addition, the window manager 620 transmits a user operation acquired via the input unit 121, to the applications 611 to 619 as an event.

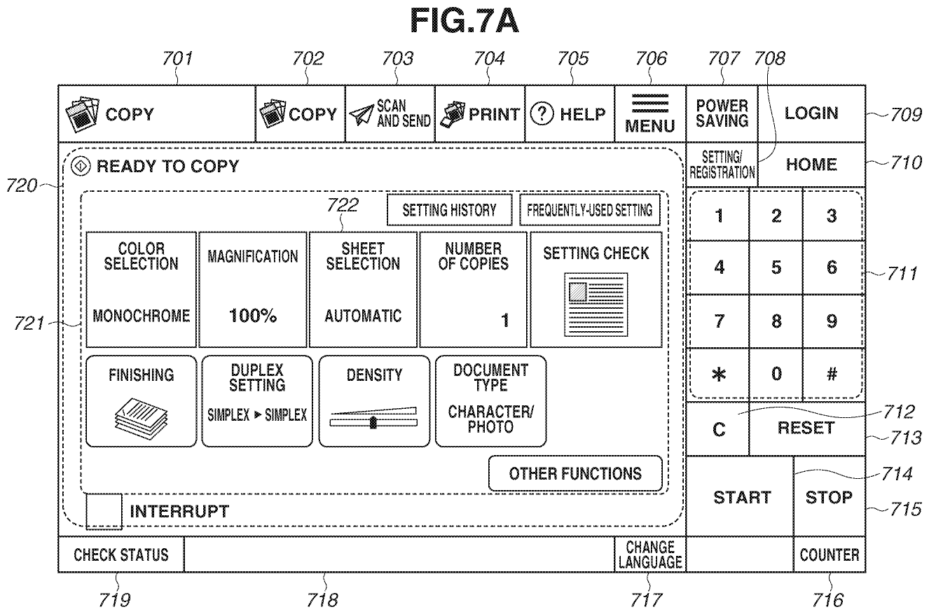

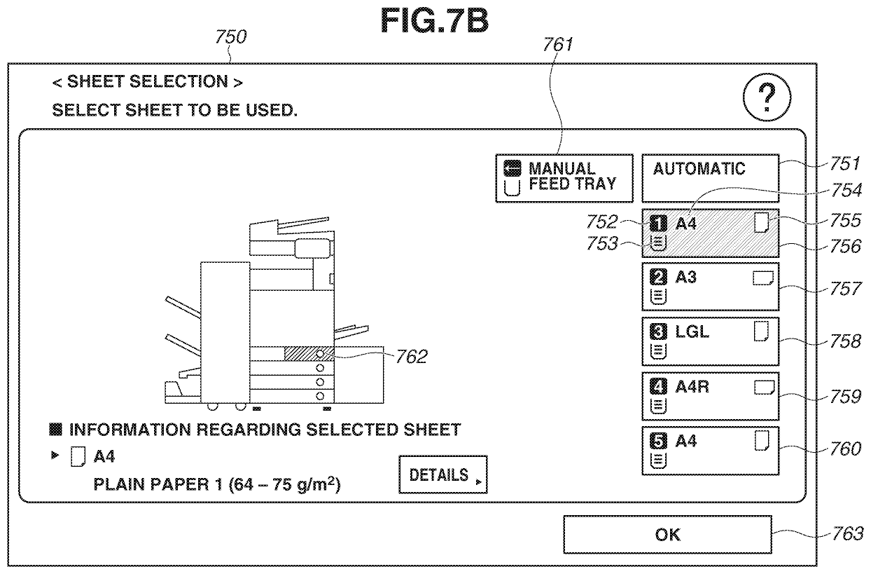

FIGS. 7A and 7B are diagrams each illustrating an example of a screen of the copy application 613 according to the first embodiment. FIG. 7A illustrates a screen (setting screen) of the copy application 613 that is to be displayed on the touch panel 550. In FIG. 7A, a region 701 is a region in which a name and an icon of a displayed application are to be displayed. Because the copy application 613 is displayed in FIG. 7A, an application name and an icon of the copy application 613 are displayed.

Shortcut buttons 702 to 705 are shortcut buttons for switching an application to be displayed. Some of the applications 611 to 619 can be allocated to the shortcut buttons 702 to 705. If the user presses any of the shortcut buttons 702 to 705, an application allocated to the pressed button is activated, and its screen is displayed on the touch panel 550. In FIG. 7A, the copy application 613 is allocated to the shortcut button 702, “scan and send” of the send/FAX application 614 is allocated to the shortcut button 703, a print application (one of other applications 619) is allocated to the shortcut button 704, and the help application 617 is allocated to the shortcut button 705.

A menu button 706 is a menu button. If the user presses the menu button 706, a menu for making various settings of the displayed application and the image processing apparatus 1 is displayed. A power saving button 707 is illustrated in FIG. 7A. If the user presses the power saving button 707, the power management unit 606 brings the image processing apparatus 1 into a power saving state. A setting/registration button 708 is illustrated in FIG. 7A. If the user presses the setting/registration button 708, the setting/registration application 618 is activated, and its screen is displayed on the touch panel 550. The user can make various settings of the image processing apparatus 1 using the setting/registration application 618. An authentication button 709 is an authentication button. When the image processing apparatus 1 is in an unauthenticated state, “login” is displayed in the authentication button 709. Here, if the user presses the authentication button 709, the authentication application 616 is displayed. By operating the authentication application 616, the user can log into the image processing apparatus 1 (bring the image processing apparatus 1 into an authenticated state). When the image processing apparatus 1 is in the authenticated state, “logout” is displayed in the authentication button 709. Here, if the user presses the authentication button 709, the authentication processing unit 604 is notified of logout of the user, and the image processing apparatus 1 enters the unauthenticated state.

A home button 710 is illustrated in FIG. 7A. If the user presses the home button 710 when an application other than the home application 611 is displayed, the home application 611 is displayed. A numerical keypad 711 for entering a numerical value is illustrated in FIG. 7A. A clear key 712 for clearing a numerical value is illustrated in FIG. 7A. A reset key 713 for resetting the setting of the displayed application is illustrated in FIG. 7A. A start key 714 for starting a job is illustrated in FIG. 7A. A stop key 715 for stopping an ongoing job is illustrated in FIG. 7A.

A counter check button 716 is illustrated in FIG. 7A. If the user presses the counter check button 716, a counter check application (one of the other applications 619) is displayed. Using the counter check application, the user can acquire the number of printed sheets printed by the image processing apparatus 1, and information regarding a license of an application installed on the image processing apparatus 1. A language change button 717 for changing a language to be used for screen display is illustrated in FIG. 7A.

A status display region 718 is illustrated in FIG. 7A in which a device state of the image processing apparatus 1 is to be displayed. A status check button 719 for displaying the status check/stop application 612 is illustrated in FIG. 7A. A content region 720 of an application is illustrated in FIG. 7A. By switching items to be displayed in the content region 720, the applications 611 to 619 provide various functions and various types of content. Because the copy application 613 is displayed in FIG. 7A, an initial screen of the copy application 613 is displayed in the content region 720. On the initial screen of the copy application 613, a plurality of buttons (721) for changing setting values of copy is arranged. A sheet selection button 722 is a button for selecting a sheet to be used in copy.

If the user presses the sheet selection button 722 (touches a corresponding position on the touch panel), the copy application 613 displays a sheet selection screen in the content region 720. FIG. 7B illustrates an example of the sheet selection screen displayed in the content region 720. In FIG. 7B, an automatic sheet selection button 751 for the user issuing an automatic sheet selection instruction is illustrated in FIG. 7B. If the automatic sheet selection instruction is issued, the image processing apparatus 1 automatically selects a sheet size of a sheet on which printing is to be performed, based on a document size detected by the reading unit 14, and various setting values. A button 756 for the user issuing a use instruction of the sheet drawer 202 is illustrated in FIG. 7B.

In the button 756, sheet feeding deck information 752 of the sheet drawer 202, and remaining amount information 753 about sheets placed in the sheet drawer 202 are displayed. In addition, size information 754 about sheets placed in the sheet drawer 202, and orientation information 755 about sheets placed in the sheet drawer 202 are further displayed. Here, in a case where a size of a sheet placed in a sheet drawer is unknown (in the case of “not applicable”), the size information 754 is hidden, and an icon indicating no remaining amount is displayed as the remaining amount information 753. Buttons 757 to 759 for the user issuing a use instruction of the sheet drawers 203 to 205 are illustrated in FIG. 7B.

A button 760 for the user issuing a use instruction of the sheet feeding deck 206 is illustrated in FIG. 7B. Similarly to the button 756, in the buttons 757 to 760, sheet feeding deck information, remaining amount information, size information, and sheet orientation information are displayed. A button 761 for the user issuing a use instruction of the manual feed tray 201 is illustrated in FIG. 7B. In the button 761, size information and sheet orientation information are not displayed, but if a sheet is placed on the manual feed tray 201, and the size and the orientation information are acquired, size information and sheet orientation information are displayed.

FIG. 7B illustrates a state in which the user has pressed the button 756, information regarding the selected sheet drawer is illustrated in a region 762. If the user presses a button 763, the copy application 613 hides the sheet selection screen, and a display state returns to the display state illustrated in FIG. 7A.

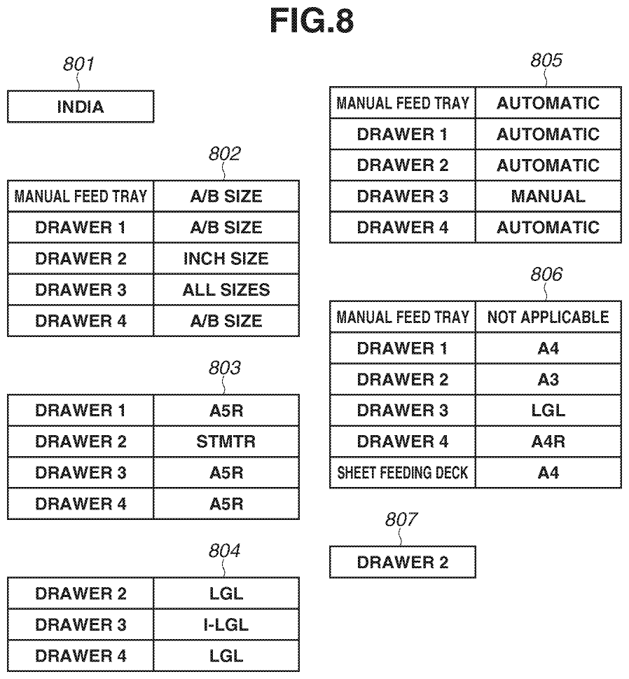

FIG. 8 is a diagram illustrating an example of data related to a destination that is held in the image processing apparatus 1 according to the first embodiment. In the image processing apparatus 1 according to the present embodiment, an operation is switched depending on a destination. The destination is information indicating a country or a region where the image processing apparatus 1 is to be used. Destination information 801 in FIG. 8 is an example of destination information. The destination information 801 is held the RAM 102 or the ROM 104, and read out by the CPU 100.

In FIG. 8, “India” is held in the destination information 801, and the destination information 801 indicates that the destination is India. If “North America” is held in the destination information 801, the destination is North America, if “China” is held, the destination is China, and if “South America” is held, the destination is South America. Examples of processing to be switched depending on the destination include sheet size automatic detection (to be described below), control of the FAX unit 106, and the setting of a default value of a display language to be switched via the language change button 717. In the image processing apparatus 1, by operating a destination change screen (not illustrated), it is also possible to change a destination held in the destination information 801.

TABLE 3
example of groups of sheet sizes, and
sheet sizes included in each group

| | |
|---|---|
| All sizes | A3, A4, A4R, A5, A5R, A6R, B4, B5, B5R, |
| | 12 × 18, 11 × 17, LTR, EXEC, LGL, LTRR, STMTR, |
| | I-LGL, 8K, 16K, 16KR |
| A/B size | A3, A4, A4R, A5, A5R, A6R, B4, B5, B5R |
| Inch size | 12 × 18, 11 × 17, LTR, EXEC, LGL, LTRR, STMTR |

In the image processing apparatus 1, sheet sizes to be automatically detected are managed while being divided into a plurality of groups. Table 3 shows an example of groups of sheet sizes, and sheet sizes included in each group. In Table 3, “A/B size” includes sheet sizes of A-series sizes and B-series sizes in Table 1. “Inch size” includes sheet sizes of Inch sizes in Table 1. “All sizes” include all sizes in Table 1. Sizes in Table 3 are held in the RAM 102 or the ROM 104, and read out by the CPU 100.

As shown in Tables 1 and 2, in the manual feed tray 201 and the sheet drawers 202 to 205, sheets with sheet sizes indistinguishable by a sensor are stored. In a case where indistinguishable sheet sizes are included in different sheet size groups, by limiting a sheet size group to be automatically detected, a sheet size can be automatically detected in some cases. For example, A5R of the group C is included in a sheet size group of A/B sizes, and STMTR is included in a sheet size group of Inch sizes. Accordingly, by limiting automatic detection target sheet sizes to A/B sizes or Inch sizes, it is possible to automatically detect either A5R or STMTR.

TABLE 4
sheet size detection result obtained when sheet size group is designated for manual feed tray 201

| | | | | | | | Width | | | |
|---|---|---|---|---|---|---|---|---|---|---|
| | | | | | | | detection | | | |
| | | Sheet | Sheet | Length detection | | | Sensor | | | |
| | | length | width | Sensor | Sensor | Sensor | 323 | | Detection result | |
| | Size | (mm) | (mm) | 303 | 304 | 305 | output | Group | A/B size | Inch size |
| A-series | A3 | 420 | 297 | ON | ON | ON | 0x358 ± | A | A3 | 12 × 18 |
| | | | | | | | 0x10 | | | |
| | A4 | 210 | 297 | ON | ON | OFF | 0x358 ± | | A4 | Not |
| | | | | | | | 0x10 | | | applicable |
| | A4R | 297 | 210 | ON | ON | OFF | 0x203 ± | B | A4R | LTRR |
| | | | | | | | 0x10 | | | |
| | A5 | 148 | 210 | ON | OFF | OFF | 0x203 ± | | A5 | Not |
| | | | | | | | 0x10 | | | applicable |
| | A5R | 210 | 148 | ON | ON | OFF | 0x111 ± | C | A5R | STMTR |
| | | | | | | | 0x10 | | | |
| | A6R | 148 | 105 | ON | OFF | OFF | 0x069 ± | | A6R | Not |
| | | | | | | | 0x10 | | | applicable |
| B-series | B4 | 364 | 257 | ON | ON | ON | 0x2bb ± | | B4 | Not |
| | | | | | | | 0x10 | | | applicable |
| | B5 | 182 | 257 | ON | ON | OFF | 0x2bb ± | | B5 | Not |
| | | | | | | | 0x10 | | | applicable |
| | B5R | 257 | 182 | ON | ON | OFF | 0x196 ± | | B5R | Not |
| | | | | | | | 0x10 | | | applicable |
| Inch-series | 12 × 18 | 457.2 | 304.8 | ON | ON | ON | 0x376 ± | A | A3 | 12 × 18 |
| | | | | | | | 0x10 | | | |
| | 11 × 17 | 431.8 | 279.4 | ON | ON | ON | 0x313 ± | | Not | 11 × 17 |
| | | | | | | | 0x10 | | applicable | |
| | LTR | 215.9 | 279.4 | ON | ON | OFF | 0x313 ± | | Not | LTR |
| | | | | | | | 0x10 | | applicable | |
| | EXEC | 184.1 | 266.7 | ON | ON | OFF | 0x2e1 ± | D | EXEC/16K | EXEC |
| | | | | | | | 0x10 | | | |
| | LGL | 355.6 | 215.9 | ON | ON | ON | 0x21a ± | E | LGL/I-LGL | LGL |
| | | | | | | | 0x10 | | | |
| | LTRR | 279.4 | 215.9 | ON | ON | OFF | 0x21a ± | B | A4R | LTRR |
| | | | | | | | 0x10 | | | |
| | STMTR | 215.9 | 139.7 | ON | ON | OFF | 0x0f1 ± | C | A5R | STMTR |
| | | | | | | | 0x10 | | | |
| Local | I-LGL | 345 | 215 | ON | ON | ON | 0x217 ± | E | LGL/I-LGL | LGL |
| size | | | | | | | 0x10 | | | |
| | 8K | 390 | 270 | ON | ON | ON | 0x2ee ± | | Not | Not |
| | | | | | | | 0x10 | | applicable | applicable |
| | 16K | 195 | 270 | ON | ON | OFF | 0x2ee ± | D | EXEC/16K | EXEC |
| | | | | | | | 0x10 | | | |
| | 16KR | 270 | 195 | ON | ON | OFF | 0x1c9 ± | | Not | Not |
| | | | | | | | 0x10 | | applicable | applicable |

A sheet size detection result obtained when a sheet size group is designated for the manual feed tray 201 in Table 1 is shown on a “detection result” column in Table 4. As shown in Table 4, by designating a sheet size group to “A/B sizes” or “Inch sizes”, it is possible to uniquely define sheet size results for the respective groups A, B, and C. Regarding the groups D and E, because included sizes are a combination of a local size (size mainly used in a certain region) and an Inch size, processing is individually performed (to be described below). In addition, in a case where a sheet size uniquely determined from output values of the sensors 303 to 305 and 323 is not included in a designated sheet size group, a detection result indicates “not applicable” (i.e., a specific sheet size is not determined).

TABLE 5
sheet size detection result obtained when sheet size groups are designated for sheet drawers 202 to 205

| | | | | Length | | | Width | | | | | | |
|---|---|---|---|---|---|---|---|---|---|---|---|---|---|
| | | Sheet | Sheet | detection | | | detection | | | | Detection result | | |
| | | length | width | Sensor | Sensor | Sensor | Sensor | Sensor | Sensor | | All | A/B | Inch |
| | Size | (mm) | (mm) | 424 | 425 | 426 | 421 | 422 | 423 | Group | sizes | size | size |
| A-series | A3 | 420 | 297 | ON | ON | OFF | OFF | OFF | ON | | A3 | A3 | Not |
| | | | | | | | | | | | | | applicable |
| | A4 | 210 | 297 | ON | ON | ON | OFF | OFF | ON | | A4 | A4 | Not |
| | | | | | | | | | | | | | applicable |
| | A4R | 297 | 210 | OFF | ON | ON | ON | ON | OFF | | A4R | A4R | Not |
| | | | | | | | | | | | | | applicable |
| | A5 | 148 | 210 | ON | OFF | OFF | ON | ON | OFF | | A5 | A5 | Not |
| | | | | | | | | | | | | | applicable |
| | A5R | 210 | 148 | ON | ON | ON | ON | OFF | OFF | C | A5R/STMTR | A5R | STMTR |
| | A6R | 148 | 105 | ON | OFF | OFF | ON | OFF | OFF | | A6R | A6R | Not |
| | | | | | | | | | | | | | applicable |
| B-series | B4 | 364 | 257 | OFF | ON | OFF | OFF | ON | OFF | | B4 | B4 | Not |
| | | | | | | | | | | | | | applicable |
| | B5 | 182 | 257 | ON | OFF | OFF | OFF | ON | OFF | | B5 | B5 | Not |
| | | | | | | | | | | | | | applicable |
| | B5R | 257 | 182 | ON | OFF | ON | ON | OFF | OFF | | B5R | B5R | Not |
| | | | | | | | | | | | | | applicable |
| | 12 × 18 | 457.2 | 304.8 | OFF | OFF | OFF | OFF | OFF | ON | | 12 × 18 | Not | 12 × 18 |
| | | | | | | | | | | | | applicable | |
| | 11 × 17 | 431.8 | 279.4 | OFF | OFF | OFF | ON | ON | ON | | 11 × 17 | Not | 11 × 17 |
| | | | | | | | | | | | | applicable | |
| | LTR | 215.9 | 279.4 | ON | ON | ON | ON | ON | ON | | LTR | Not | LTR |
| | | | | | | | | | | | | applicable | |
| | EXEC | 184.1 | 266.7 | ON | OFF | OFF | OFF | ON | ON | | EXEC | Not | EXEC |
| | | | | | | | | | | | | applicable | |
| Inch-series | LGL | 355.6 | 215.9 | OFF | ON | OFF | ON | ON | OFF | E | LGL/I-LGL | LGL/I-LGL | LGL |
| | LTRR | 279.4 | 215.9 | OFF | OFF | ON | ON | ON | OFF | | LTRR | Not | LTRR |
| | | | | | | | | | | | | applicable | |
| | STMTR | 215.9 | 139.7 | ON | ON | ON | ON | OFF | OFF | C | A5R/STMTR | A5R | STMTR |
| Local | I-LGL | 345 | 215 | OFF | ON | OFF | ON | ON | OFF | E | LGL/I-LGL | LGL/I-LGL | LGL |
| size | 8K | 390 | 270 | ON | ON | OFF | OFF | ON | ON | | 8K | Not | Not |
| | | | | | | | | | | | | applicable | applicable |
| | 16K | 195 | 270 | ON | ON | ON | OFF | ON | ON | | 16K | Not | Not |
| | | | | | | | | | | | | applicable | applicable |
| | 16KR | 270 | 195 | OFF | OFF | ON | ON | OFF | OFF | | 16KR | Not | Not |
| | | | | | | | | | | | | applicable | applicable |

Similarly, a sheet size detection result obtained when sheet size groups are designated for the sheet drawers 202 to 205 in Table 2 is shown on a “detection result” column in Table 5. By designating a sheet size group to “A/B sizes” or “Inch size”, it is possible to uniquely determine a sheet size result for the group C. Regarding the group E, because included sizes are a combination of a local size and an Inch size, in the present embodiment, processing is individually performed (to be described below). Because many sheet sizes of sheets in the sheet drawers 202 to 205 are sheet sizes that can be determined without designating a sheet size group, “all sizes” can be set as sheet size automatic detection targets.

In the image processing apparatus 1, it is possible to set a sheet size group to be set as a sheet size automatic detection target, for each sheet feeding deck (each sheet feeding unit). Furthermore, it is also possible to change a sheet size automatic detection target group of each sheet feeding deck in accordance with an instruction issued by the user.

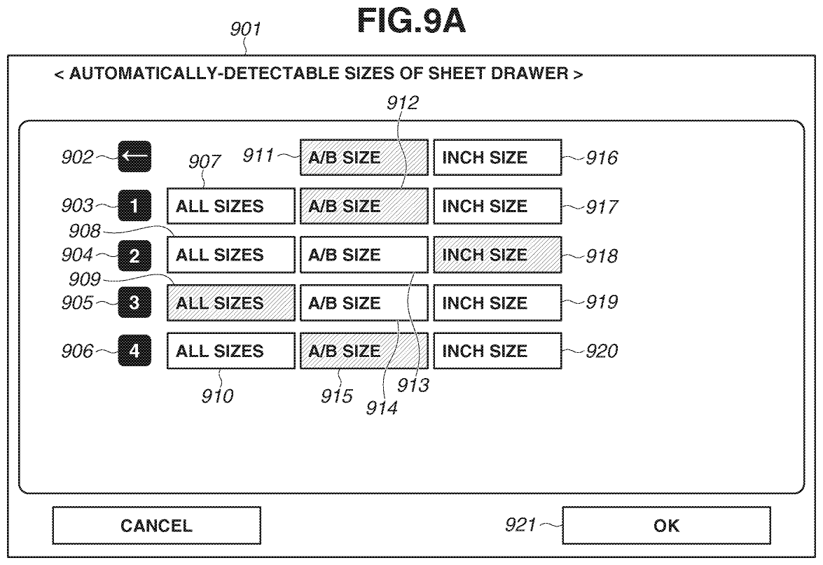

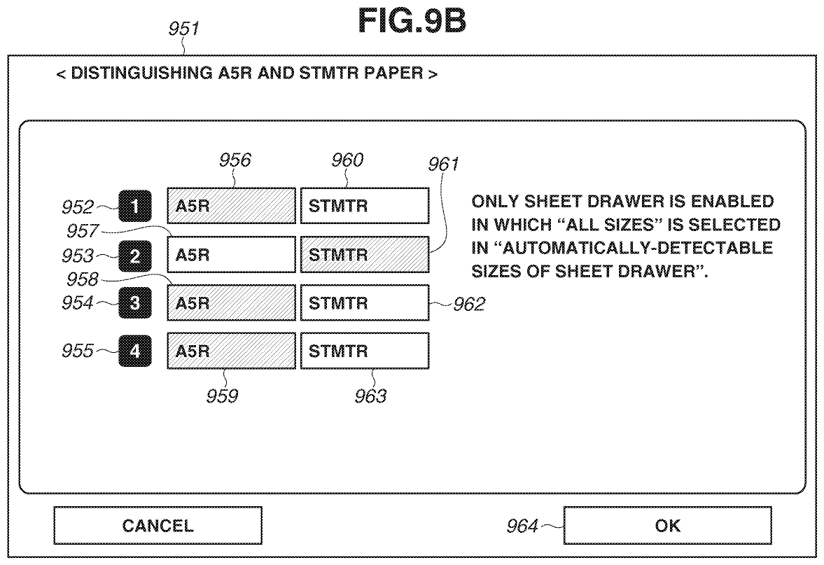

FIGS. 9A and 9B are diagrams each illustrating an example of a setting screen of the image processing apparatus 1 according to the first embodiment. FIG. 9A illustrates an example of a screen for changing a sheet size automatic detection target group. A sheet size automatic detection target group change screen 901 is displayed in the content region 720 by the user pressing the setting/registration button 708, activating the setting/registration application 618, and following a predetermined hierarchy. On the sheet size automatic detection target group change screen 901, sheet feeding deck information 902 to 906, all sizes designation buttons 907 to 910, A/B size designation buttons 911 to 915, and inch size designation buttons 916 to 920 are arranged. The sheet feeding deck information 902 to 906 is equivalent to sheet feeding deck information on the sheet selection screen 750. The all sizes designation buttons 907 to 910 are buttons for setting a sheet size automatic detection target to all sizes for a target sheet feeding deck. The A/B size designation buttons 911 to 915 are buttons for setting a sheet size automatic detection target to A/B sizes for a target sheet feeding deck. The inch size designation buttons 916 to 920 are buttons for setting a sheet size automatic detection target to inch sizes for a target sheet feeding deck.

Because the manual feed tray 201 cannot perform sheet size automatic detection of all sizes, an all sizes designation button corresponding to the manual feed tray 201 is not displayed. In addition, because the sheet feeding deck 206 cannot execute sheet size automatic detection, a button corresponding to the sheet feeding deck 206 is not displayed. In addition, an all sizes designation button, an A/B size designation button, and an inch size designation button are exclusive, and only one can be selected for each sheet feeding deck.

TABLE 6
default value of sheet size automatic detection
target group of each destination

| | | |
|---|---|---|
| (A) | North America | Inch size |
| | China | A/B size |
| | Japan | A/B size |
| | Europe | A/B size |
| | India | A/B size |
| | South America | All sizes |
| | Others | All sizes |
| (B) | North America | STMTR |
| | China | A5R |
| | Japan | A5R |
| | Europe | A5R |
| | India | A5R |
| | South America | A5R |
| | Others | A5R |
| (C) | North America | LGL |
| | China | LGL |
| | Japan | LGL |
| | Europe | LGL |
| | India | I-LGL |
| | South America | LGL |
| | Others | LGL |

In the image processing apparatus 1 of the present embodiment, a default value (initial value) of a sheet size automatic detection target group varies depending on the destination. Table 6A shows an example of a default value of a sheet size automatic detection target group of each destination. The sizes in Table 6A are held in the RAM 102 or the ROM 104, and read out by the CPU 100. Then, if the user operates the button 907 to 920 and presses an OK button 921, information regarding a sheet size automatic detection target group is held into the RAM 102 or the HDD 103 in accordance with a pressed state of the buttons 907 to 920. Sheet size automatic detection target group information 802 in FIG. 8 is an example of sheet size automatic detection target group information to be held in the RAM 102 or the HDD 103.

In a case where a sheet size indistinguishable by a sensor is detected in each sheet feeding deck, and a sheet size automatic detection target group set in the sheet size automatic detection target group information 802 is “all sizes”, the image processing apparatus 1 determines a sheet size based on sheet size selection information. The sheet size selection information can be set in each sheet feeding deck in the image processing apparatus 1 according to the present embodiment. Furthermore, in the image processing apparatus 1, it is also possible to change sheet size selection information in accordance with an instruction issued by the user.

FIG. 9B illustrates an example of a screen for changing sheet size selection information for the group C (A5R, STMTR) in Table 2. An A5R/STMTR selection screen 951 is displayed in the content region 720 by the user pressing the setting/registration button 708, activating the setting/registration application 618, and following a predetermined hierarchy. On the A5R/STMTR selection screen 951, sheet feeding deck information 952 to 955, A5R selection buttons 956 to 959, and STMTR selection buttons 960 to 963 are arranged. Because the manual feed tray 201 cannot perform sheet size automatic detection of all sizes, a button corresponding to the manual feed tray 201 is not displayed. Because the sheet feeding deck 206 cannot perform sheet size automatic detection, a button corresponding to the sheet feeding deck 206 is not displayed. An A5R selection button and an STMTR selection button are exclusive, and only one can be selected for each sheet feeding deck.

In the present embodiment, a default value of A5R/STMTR selection varies depending on the destination. Table 6B shows an example of a default value of A5R/STMTR selection of each destination. The sizes in Table 6B are held in the RAM 102 or the ROM 104, and read out by the CPU 100. If the user operates the buttons 956 to 963 and presses an OK button 964, information regarding a selection result of A5R/STMTR is held into the RAM 102 or the HDD 103 in accordance with a pressed state of the buttons 956 to 963. Information 803 in FIG. 8 is an example of A5R/STMTR selection information to be held in the RAM 102 or the HDD 103.

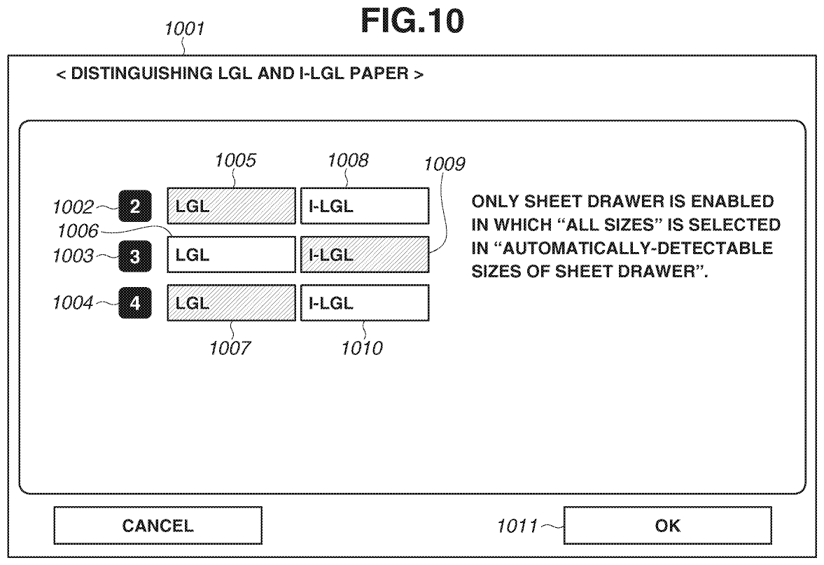

FIG. 10 is a diagram illustrating an example of a setting screen of the image processing apparatus 1 according to the first embodiment. FIG. 10 illustrates an example of a screen for changing sheet size selection information for the group E (legal (LGL) and India legal (I-LGL)) in Table 2. An LGL/I-LGL selection screen 1001 is displayed in the content region 720 by the user pressing the setting/registration button 708, activating the setting/registration application 618, and following a predetermined hierarchy. On the LGL/I-LGL selection screen 1001, sheet feeding deck information 1002 to 1004, LGL selection buttons 1005 to 1007, and I-LGL selection buttons 1008 to 1010 are arranged. Because the manual feed tray 201 cannot perform sheet size automatic detection of all sizes, a button corresponding to the manual feed tray 201 is not displayed. Because the sheet drawer 202 is small in size and an LGL or I-LGL sheet cannot be placed thereon, a button corresponding to the sheet drawer 202 is not displayed. Because the sheet feeding deck 206 cannot perform sheet size automatic detection, a button corresponding to the sheet feeding deck 206 is not displayed. An LGL selection button and an I-LGL selection button are exclusive, and only one can be selected for each sheet feeding deck.

In the present embodiment, a default value of LGL/I-LGL selection varies depending on the destination. Table 6C shows an example of a default value of LGL/I-LGL selection of each destination. The sizes in Table 6C are held in the RAM 102 or the ROM 104, and read out by the CPU 100. If the user operates the buttons 1005 to 1010 and presses the OK button 1011, information regarding an LGL/I-LGL selection result is held into the RAM 102 or the HDD 103 in accordance with a pressed state of the buttons 1005 to 1010. Information 804 in FIG. 8 is an example of LGL/I-LGL selection information to be held in the RAM 102 or the HDD 103. In the image processing apparatus 1 according to the present embodiment, by the user manually setting a sheet size, it is possible to use a sheet with a size not shown in Table 3.

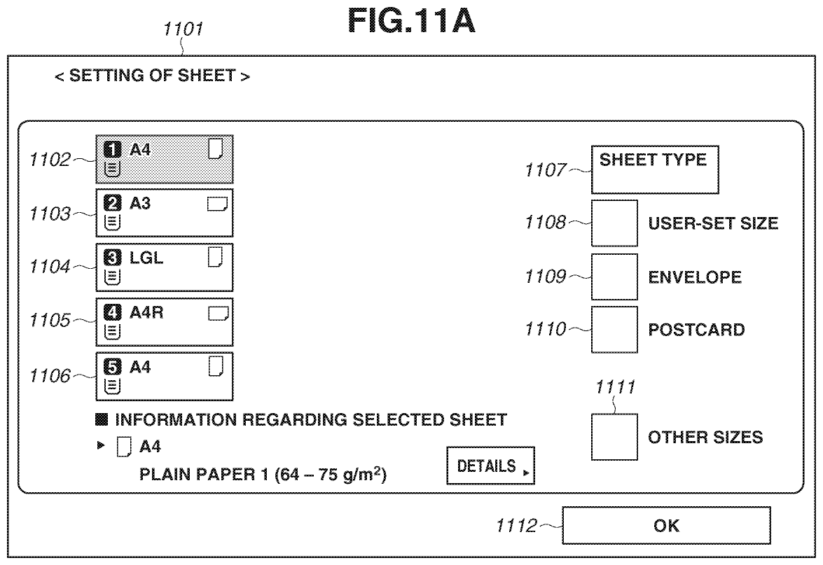

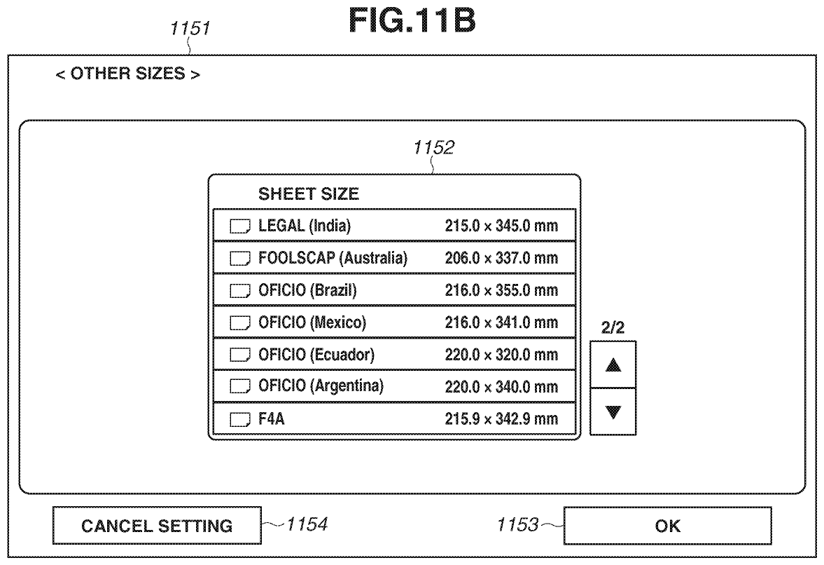

FIGS. 11A and 11B are diagrams each illustrating an example of a setting screen of the image processing apparatus 1 according to the first embodiment. FIGS. 11A and 11B illustrate an example of a screen for manually setting a sheet size. A sheet setting screen 1101 is displayed in the content region 720 by the user pressing the setting/registration button 708, activating the setting/registration application 618, and following a predetermined hierarchy. On the sheet setting screen 1101, sheet feeding deck selection buttons 1102 to 1106, a sheet type button 1107, a user-set size button 1108, an envelope button 1109, a postcard button 1110, and other sizes button 1111 are arranged. In the sheet feeding deck selection buttons 1102 to 1106, information similar to the sheet feeding deck selection buttons 756 to 760 is displayed, and is used to select a setting target. The sheet type button 1107 is used to set sheet types including sheet properties such as grammage and a surface property.

The user-set size button 1108 is used to set a width and a length of a non-standard sheet size by numerical values. The envelope button 1109 is used to set a size and a type of an envelope. The postcard button 1110 is used to set a size and a type of a postcard. If the user selects a sheet feeding deck by pressing any of the sheet feeding deck selection buttons 1102 to 1106, and presses the buttons 1107 to 1110, a setting screen (not illustrated) corresponding to a pressed button is displayed, and it is possible to make settings of the selected sheet feeding deck thereon. The other sizes button 1111 is used to set other sheet sizes.

If the user selects a sheet feeding deck by pressing any of the sheet feeding deck selection buttons 1102 to 1106, and presses the other sizes button 1111, other sizes setting screen 1151 corresponding to the selected sheet feeding deck is displayed. On the other sizes setting screen 1151, a sheet size list 1152 is a sheet size list for selecting a sheet size. In the sheet size list 1152, sheet sizes including sizes not shown in Table 3 are displayed. If the user selects a list item from the sheet size list 1152 and presses the OK button 1153, a sheet size corresponding to the selected list item is held into the RAM 102 or the HDD 103 as a manually-set size. Information pieces 805 and 806 in FIG. 8 are examples of sheet size information to be held in the RAM 102 or the HDD 103. The sheet size information 805 is a flag indicating a type of “automatic” or “manual”. The sheet size information 806 is a region in which a selected sheet size is held. The sheet size information 806 is used also to hold a result of sheet size automatic detection.

If the user presses a setting cancel button 1154 on the other sizes setting screen 1151, a manually-set sheet size is cancelled and a sheet size is automatically detected. In other words, the setting in the sheet size information 805 changes to “automatic”, and an automatically-detected sheet size is held in the sheet size information 806. After the OK button 1153 or the setting cancel button 1154 is pressed, the other sizes setting screen 1151 is hidden. The settings of the sheet size information 805 and 806 for the manual feed tray 201, and the setting of the sheet size information 806 for the sheet feeding deck 206 are made on a screen (not illustrated) different from the other sizes setting screen 1151.

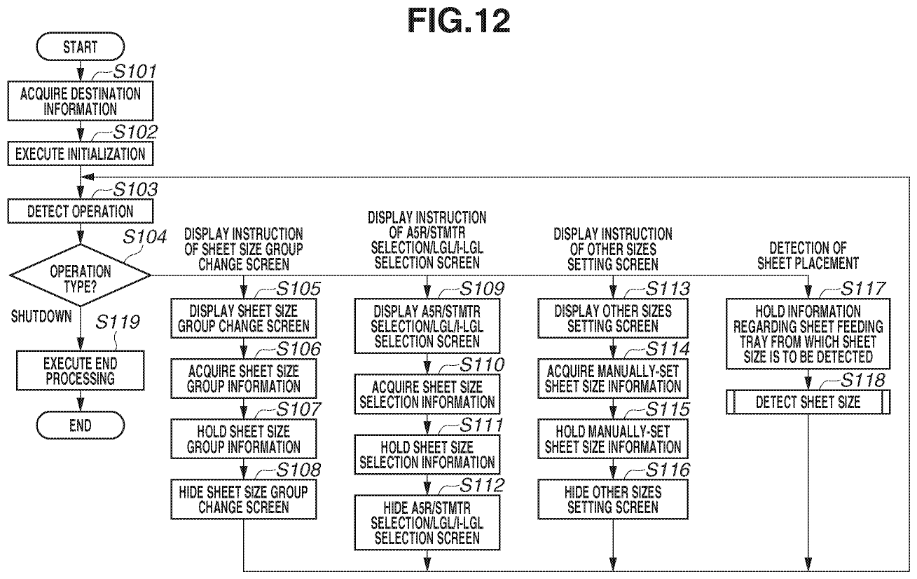

FIG. 12 is a flowchart illustrating a processing flow of the image processing apparatus 1 according to the present embodiment. The processing flows illustrated in FIG. 12 and other flowcharts are described as programs, and held in the ROM 104 or the HDD 103. The CPU 100 reads the programs, and executes each step in accordance with the processing flows.

If the user operates the main power switch 200 and activates the image processing apparatus 1, the CPU 100 reads a program held in the ROM 104 or the HDD 103, and starts the processing flow illustrated in FIG. 12. In the processing flow illustrated in FIG. 12, first of all, in step S101, the CPU 100 acquires a destination set in the destination information 801.

In step S102, the CPU 100 performs initialization of the image processing apparatus 1. For example, processing such as warm-up of the printer 111 is included in this step. In addition, the CPU 100 reads information held in Tables 1 to 6 and the like, from the HDD 103, and holds the read information into the RAM 102. In addition, the CPU 100 initializes as necessary the information held in the regions illustrated in FIG. 8.

In step S103, the CPU 100 detects a user operation performed on the image processing apparatus 1. Examples of user operations to be detected in this step include an operation on the touch panel 550, insertion of the sheet drawers 202 to 205, and sheet placement on the manual feed tray 201, and the details will be complemented in the description of step S104.

In step S104, the CPU 100 branches the processing based on an operation detected in step S103.

If the operation detected in step S103 is a display instruction of the sheet size automatic detection target group change screen 901 (“DISPLAY INSTRUCTION OF SHEET SIZE GROUP CHANGE SCREEN” in step S103), the processing proceeds to step S105. If the operation detected in step S103 is a display instruction of the A5R/STMTR selection screen 951 or the LGL/I-LGL selection screen 1001 (“DISPLAY INSTRUCTION OF A5R/STMTR SELECTION/LGL/I-LGL SELECTION SCREEN” in step S103), the processing proceeds to step S109. If the operation detected in step S103 is a display instruction of the other sizes setting screen 1151 (“DISPLAY INSTRUCTION OF OTHER SIZES SETTING SCREEN” in step S103), the processing proceeds to step S113. If the operation detected in step S103 is insertion of the sheet drawers 202 to 205 or sheet placement on the manual feed tray 201 (“DETECTION OF SHEET PLACEMENT” in step S103), the processing proceeds to step S118. If the operation detected in step S103 is a shutdown instruction of the image processing apparatus 1 such as an operation on the main power switch 200 (“SHUTDOWN” in step S103), the processing proceeds to step S119.

In step S105, the CPU 100 displays the sheet size automatic detection target group change screen 901 on the touch panel 550. Next, in step S106, the CPU 100 detects an operation on the sheet size automatic detection target group change screen 901, and acquire a sheet size automatic detection target group for each sheet feeding deck. Then, in step S107, the CPU 100 holds the sheet size automatic detection target group acquired in step S106, into the sheet size automatic detection target group information 802. Furthermore, in step S108, the CPU 100 hides the sheet size automatic detection target group change screen 901. After step S108, the processing returns to step S103.

In step S109, the CPU 100 displays the A5R/STMTR selection screen 951 or the LGL/I-LGL selection screen 1001 on the touch panel 550 based on the operation detected in step S103. Next, in step S110, the CPU 100 detects an operation on the screen displayed in step S109, and acquires sheet size selection information for each sheet feeding deck. Then, in step S111, the CPU 100 holds the sheet size selection information acquired in step S110, into the A5R/STMTR selection information 803 or the LGL/I-LGL selection information 804 in accordance with the screen displayed in step S109. Furthermore, in step S112, the CPU 100 hides the screen displayed in step S109. After step S112, the processing returns to step S103.

In step S113, the CPU 100 displays the other sizes setting screen 1151 on the touch panel 550. Next, in step S114, the CPU 100 detects an operation on the other sizes setting screen 1151, and acquires sheet size information for a target sheet feeding deck. Then, in step S115, the CPU 100 updates a flag in the sheet size information 805 and the sheet size information 806 based on the sheet size information acquired in step S114. Furthermore, in step S116, the CPU 100 hides the other sizes setting screen 1151. After step S116, the processing returns to step S103.

In step S117, the CPU 100 holds a sheet feeding deck on which sheet placement is detected in step S103, as sheet size detection target sheet feeding deck information. If the operation detected in step S103 is insertion of the sheet drawers 202 to 205, a corresponding sheet drawer becomes a sheet size detection target sheet feeding deck. If the operation detected in step S103 is sheet placement on the manual feed tray 201, the manual feed tray 201 becomes a sheet size detection target sheet feeding deck. Information 807 in FIG. 8 is an example of sheet size detection target sheet feeding deck information. The sheet size detection target sheet feeding deck information 807 is held in the RAM 102. After step S117, the processing proceeds to step S118.

The processing in step S118 is a subroutine of detecting a size of a sheet of which the placement on a sheet feeding deck has been detected in step S103. Operations in this subroutine will be described below. If the subroutine for sheet size detection ends, the processing returns to step S103.

In step S119, the CPU 100 holds, into the HDD 103, information that needs to be stored, among information items held in the RAM 102, such as the sheet size automatic detection target group information 802. After step S119, the processing flow illustrated in FIG. 12 ends.

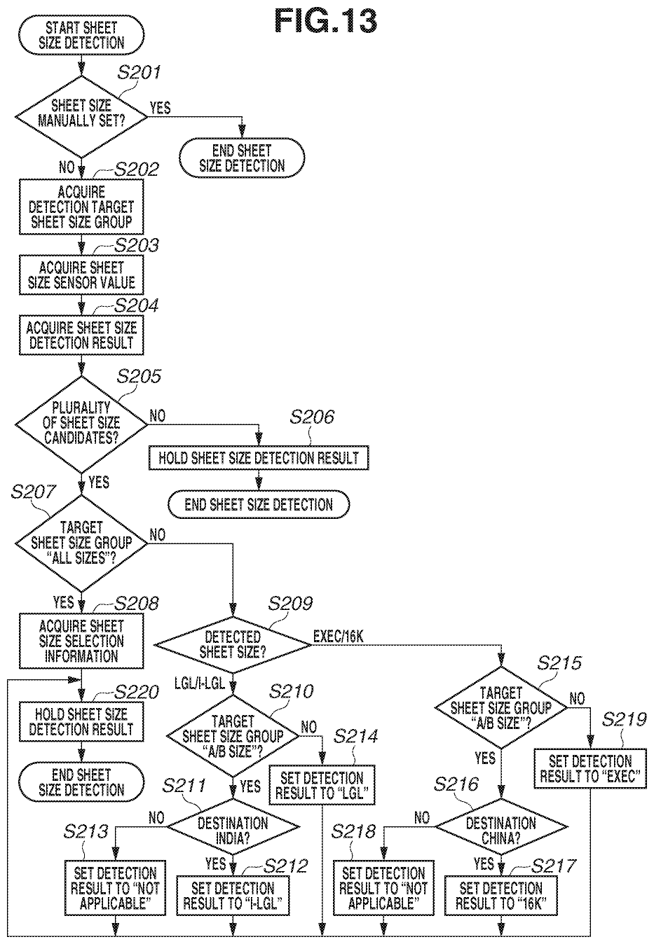

FIG. 13 is a flowchart illustrating processing of the subroutine (step S118 in FIG. 12) of detecting a sheet size in the present embodiment. If the subroutine of detecting a sheet size is invoked, first of all, in step S201, the CPU 100 acquires information corresponding to a sheet feeding deck that is held in the sheet size detection target sheet feeding deck information 807, from the sheet size information 805.

Then, the CPU 100 determines whether a sheet size of a target sheet feeding deck is manually set. If the flag held in the sheet size information 805 indicates “manual” (YES in step S201), the CPU 100 ends the subroutine of detecting a sheet size. If not (NO in step S201), the processing proceeds to step S202.

In step S202, referring to the sheet size automatic detection target group information 802, the CPU 100 acquires a sheet size automatic detection target group set in accordance with a sheet feeding deck held in the sheet size detection target sheet feeding deck information 807. Next, in step S203, the CPU 100 acquires a sensor value for detecting a sheet size, from the sheet feeding deck held in the sheet size detection target sheet feeding deck information 807. If a sheet feeding deck held in the sheet size detection target sheet feeding deck information 807 is the manual feed tray 201, the CPU 100 acquires values of the sensors 303 to 304 and 323. In other cases, the CPU 100 acquires values of the sensors 421 to 426.

In step S204, the CPU 100 acquires a sheet size detection result by searching Table 4 or 5 based on the automatic detection target group acquired in step S202, and sensor values acquired in step S203. If a sheet feeding deck held in the sheet size detection target sheet feeding deck information 807 is the manual feed tray 201, the CPU 100 searches “length detection” and “width detection” columns in Table 4 for a row corresponding to values of the sensors 303 to 304 and 323. Then, the CPU 100 sets a value on a “detection result” column to which the automatic detection target group corresponds, as a sheet size detection result. If a sheet feeding deck held in the sheet size detection target sheet feeding deck information 807 is any of the sheet drawers, the CPU 100 searches “length detection” and “width detection” columns in Table 5 for a row corresponding to values of the sensors 421 to 426. Then, based on a search result, the CPU 100 sets a value on a “detection result” column to which the automatic detection target group corresponds, as a sheet size detection result.

In step S205, the CPU 100 determines whether the sheet size detection result acquired in step S204 includes a plurality of sheet sizes. In other words, in step S205, the CPU 100 determines whether there is a plurality of sheet size candidates, using a sensor corresponding to a sheet feeding deck. If a plurality of sheet size detection results acquired in step S204 is any of “A5R/STMTR”, “LGL/I-LGL”, and “EXEC/16K” (YES in step S205), the processing proceeds to step S207. If not (NO in step S205), the processing proceeds to step S206. In step S206, the CPU 100 holds the sheet size detection result acquired in step S204, into the sheet size information 806, and ends the subroutine of detecting a sheet size. Here, for example, a sheet size detection result including “A5R/STMTR” means that results detected as sheet size candidates are A5R and STMTR.

In step S207, the CPU 100 determines whether the sheet size automatic detection target group acquired in step S202 is “all sizes”. If the sheet size automatic detection target group acquired in step S202 is “all sizes” (YES in step S207), the processing proceeds to step S208. If not (NO in step S207), the processing proceeds to step S209.

In step S208, the CPU 100 acquires a sheet size detection result from the sheet size detection result acquired in step S204, and sheet size selection information held in the information 803 or 804. If a sheet size detection result acquired in step S204 is “A5R/STMTR (A5R and STMTR)”, referring to the A5R/STMTR selection information 803, the CPU 100 sets a sheet size corresponding to a target sheet feeding deck held in the sheet size detection target sheet feeding deck information 807, as a sheet size detection result. Alternatively, in step S208, if a sheet size detection result acquired in step S204 is “LGL/I-LGL”, referring to the LGL/I-LGL selection information 804, the CPU 100 sets a sheet size corresponding to a target sheet feeding deck, as a sheet size detection result. After step S208, the processing proceeds to step S220.

In step S209, the CPU 100 branches the processing based on the sheet size detection result acquired in step S204. If the sheet size detection result acquired in step S204 is “LGL/I-LGL (LGL and I-LGL)” (“LGL/I-LGL” in step S209), the processing proceeds to step S210. If the sheet size detection result acquired in step S204 is “EXEC/16K (EXEC and 16K)” (“EXEC/16K” in step S209), the processing proceeds to step S215.

In step S210, the CPU 100 determines whether the sheet size automatic detection target group acquired in step S202 is the “A/B size”. If the sheet size automatic detection target group acquired in step S202 is the “A/B size” (YES in step S210), the processing proceeds to step S211. If not (NO in step S210), the processing proceeds to step S214.

In step S211, the CPU 100 determines whether a destination held in the destination information 801 is “India”. If a destination held in the destination information 801 is “India” (YES in step S211), the processing proceeds to step S212. If not (NO in step S211), the processing proceeds to step S213. In step S212, the CPU 100 sets a sheet size detection result to “I-LGL”, and the processing proceeds to step S220.

In step S213, the CPU 100 sets a sheet size detection result to “not applicable”, and the processing proceeds to step S220. In the case of a destination for which the sheet size group is “A/B size”, if “LGL/I-LGL” is detected for a destination other than India, there is high possibility that the position of the guide (403, etc.) is inappropriate (does not fit with the end of the sheet). In a case where a guide position is inappropriate, because trouble such as a paper jam might be caused, in this step S213, a sheet size detection result is set to “not applicable”, and the target sheet feeding deck (802) is made unusable in the copy application 613. In step S214, the CPU 100 sets a sheet size detection result to “LGL”, and the processing proceeds to step S220.

In step S215, the CPU 100 determines whether the sheet size automatic detection target group acquired in step S202 is “A/B size”. If the sheet size automatic detection target group acquired in step S202 is “A/B size” (YES in step S215), the processing proceeds to step S216. If not (NO in step S215), the processing proceeds to step S219. In step S216, the CPU 100 determines whether a destination held in the destination information 801 is “China”. If a destination held in the destination information 801 is “China” (YES in step S216), the processing proceeds to step S217. If not (NO in step S216), the processing proceeds to step S218.

In step S217, the CPU 100 sets a sheet size detection result to “16K”, and the processing proceeds to step S220. In step S218, the CPU 100 sets a sheet size detection result to “not applicable”, and the processing proceeds to step S220. In step S219, the CPU 100 sets a sheet size detection result to “EXEC”, and the processing proceeds to step S220. In step S220, the CPU 100 holds the sheet size detection results determined in steps S208, S212 to S214, and S217 to S219, into the sheet size information 806, and ends the subroutine of detecting a sheet size.

Heretofore, according to the present embodiment, in a case where “LGL/I-LGL” is detected and in a case where “A/B size” is selected as an automatic detection target group, the subsequent processing is switched as described in step S211. In other words, in a case where a destination is India, there is a high possibility that the sheet size is India legal (I-LGL), and a sheet size is accordingly determined to be a I-LGL. Nevertheless, even in a country or a region where the “A/B size” is selected, if “LGL/I-LGL” is detected in a destination (for example, Japan) other than India, there is a low possibility that “LGL/I-LGL” is used. When “LGL/I-LGL” is detected in a destination other than India, there is a higher possibility that the position of a guide regulating the position of a sheet is inappropriate. For this reason, in such a case, a sheet size is determined to be “not applicable”. With this configuration, in the present embodiment, it becomes possible to easily make settings of the information processing apparatus even for a sheet size indistinguishable by a sheet size detection mechanism.

### OTHER EMBODIMENTS

In the first embodiment, in step S204, the CPU 100 refers to Tables 4 and 5, and in a case where there is a plurality of sheet size detection results, in steps S211 and S216, the CPU 100 refers to destination information. In contrast to this, a configuration of changing an item for which a plurality of sheet size detection results is obtained in Tables 4 and 5, after the acquisition of destination information can also be employed. In this case, after destination information is acquired in step S101, in initialization in step S102, information stored in Tables 4 and 5 arranged in the RAM 102 is changed.

Specifically, among items for which a “detection result” is “LGL/I-LGL” in Tables 4 and 5, an item of which a sheet size group is “A/B size” is replaced with “I-LGL” or “not applicable” in accordance with destination information. At this time, if a destination information indicates “India”, the item is replaced with “I-LGL”, and in other cases, the item is replaced with “not applicable”. Furthermore, among items for which a “detection result” is “EXEC/16K” in Table 4, an item of which a sheet size group is “A/B size” is replaced with “16K” or “not applicable” in accordance with destination information. At this time, if destination information indicates “China”, the item is replaced with “16K”, and in other cases, the item is replaced with “not applicable”.

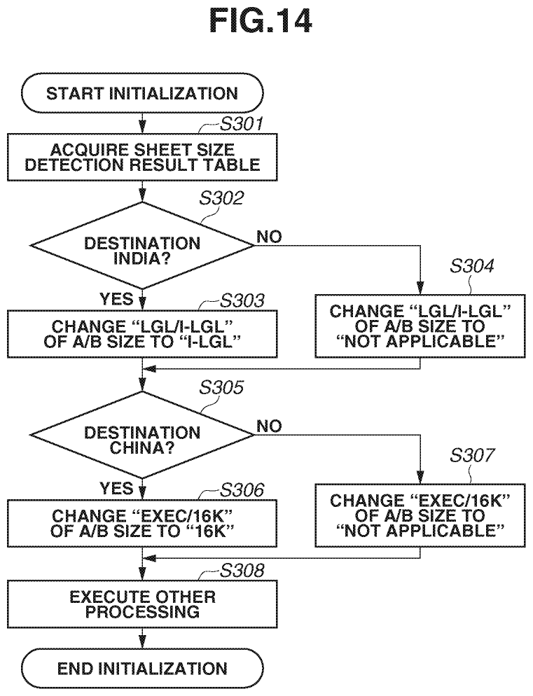

FIG. 14 is a flowchart illustrating a processing flow in step S102 that is to be performed in the case of changing an item for which a plurality of sheet size detection results is in Tables 4 and 5, after the acquisition of destination information. If the processing in step S102 starts, first of all, in step S301, the CPU 100 acquires information in Tables 4 and 5 arranged in the RAM 102 that is held in the RAM 102. Next, in step S302, the CPU 100 refers to the destination information acquired in step S101, and if the destination information indicates “India” (YES in step S302), the processing proceeds to step S303. If not (NO in step S302), the processing proceeds to step S304.

In step S303, in the information in Tables 4 and 5 that has been acquired in step S102, an item corresponding to “LGL/I-LGL” on an “A/B size” column of a “detection result” column is replaced with “I-LGL”. In step S304, in the information in Tables 4 and 5 that has been acquired in step S102, an item corresponding to “LGL/I-LGL” on the “A/B size” column of the “detection result” column is replaced with “not applicable”. After steps S303 and S304, the processing proceeds to step S305.

In step S305, the CPU 100 refers to the destination information acquired in step S101, and if the destination information indicates “China” (YES in step S305), the processing proceeds to step S306. If not (NO in step S305), the processing proceeds to step S307.

In step S306, in the information in Tables 4 and 5 that has been acquired in step S102, an item corresponding to “EXEC/16K” on the “A/B size” column of the “detection result” column is replaced with “16K”. In step S307, in the information in Tables 4 and 5 that has been acquired in step S102, an item corresponding to “EXEC/16K” on the “A/B size” column of the “detection result” column is replaced with “not applicable”. After steps S306 and S307, the processing proceeds to step S308. In step S308, the CPU 100 performs other processing, and ends the initialization processing in step S102. The processing flow illustrated in FIG. 14 may be performed in accordance with the detection of a change in destination information.

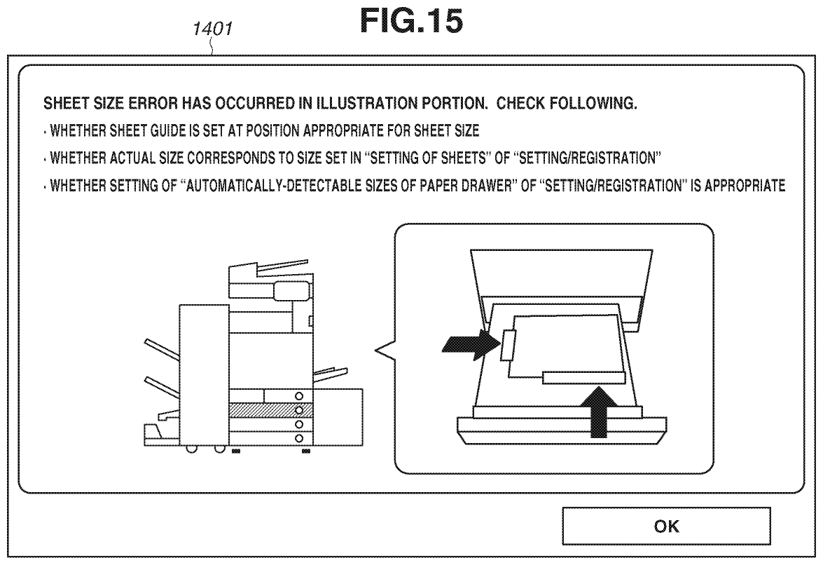

The ADF 142 also includes sensors similar to those of the manual feed tray 201 (518 to 520 in FIGS. 5A and 5B). Thus, the present embodiment can also be applied to document size detection in the ADF 142. In addition, in a case where a sheet size detection result is set to “not applicable” in steps S213 and S218, an error screen as illustrated in FIG. 15 may be displayed in the content region 720. With this configuration, for example, in a case where “LGL/I-LGL” is detected due to an inappropriate position of the guide (403, etc.) for a destination other than India of which a sheet size group is “A/B size”, the user can be notified of an error at a timing at which a sheet is detected.

TABLE 7
information regarding detailed type of destination

| | |
|---|---|
| North America | United States, Canada |
| China | China |
| Japan | Japan |
| Europe | United Kingdom, Italy, Netherlands, Sweden, |
| | Spain, Germany, France, Portugal, . . . |
| India | India |
| South America | Argentina, Brazil, . . . |
| Others | Australia, Singapore, Thailand, Vietnam, |
| | South Korea, . . . |

In addition, regarding the destination information 801, a configuration of holding information regarding a more detailed country or region than a destination type used in Table 6, such as “United States”, “United Kingdom”, and “Argentina”, into the destination information 801, and referring to Table 6 via a table shown in Table 7 may be employed. The table shown in Table 7 is held in the RAM 102 or the ROM 104, and read out by the CPU 100 similarly to the other tables.

In addition, in place of the destination information 801, information indicating a utilization site of the image processing apparatus 1 may be used. For example, in place of the destination information 801, a display language used in the operation unit 12 may be used. In this case, in step S101, information regarding the display language is acquired from the device information management unit 607. In steps S211 and S216, determination is made based on the display language information acquired in step S101.

In addition, in place of the destination information 801, position information acquired from the communication unit 101 using an internet protocol (IP) address or Wi-Fi, or position information acquired from a communication setting of the FAX unit 106 may be used. In this case, in step S101, position information is acquired from the communication unit 101 or the FAX unit 106. In steps S211 and S216, determination is made based on the position information acquired in step S101.

It becomes possible to easily make settings of the information processing apparatus even for a sheet size indistinguishable by a sheet size detection mechanism.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-050806, filed Mar. 25, 2025, which is hereby incorporated by reference herein in its entirety.

What is claimed is:

1. An information processing apparatus configured to execute predetermined processing on a sheet with a first size or a second sheet with a second size different from the first size, the information processing apparatus comprising:
one or more processors; and
one or more memories storing instructions that, when executed by the one or more processors, cause the information processing apparatus to function as:
an acquisition unit configured to acquire information regarding a utilization site of the information processing apparatus;
a first selection unit configured to select any of a plurality of size groups including a first size group including the first size, and a second size group including the second size;
a detection unit configured to detect a candidate of a size of a sheet on which the predetermined processing is to be executed;
a determination unit configured to determine, based on a selection result obtained by the selection unit and a candidate of a sheet size detected by the detection unit, a size of a sheet on which the predetermined processing is to be executed; and
a processing unit configured to execute the predetermined processing based on the determined size of the sheet,
wherein, in a case where the selection result is the first size group and a candidate of a sheet size detected by the detection unit includes the first size and the second size, the determination unit determines, based on information regarding a utilization site that has been acquired by the acquisition unit, being information regarding a first site, a sheet size to be the first sheet size, and
wherein based on information regarding a utilization site that has been acquired by the acquisition unit, being information regarding a second site different from the first site, the determination unit does not determine a sheet size to be a specific sheet size.

2. The information processing apparatus according to claim 1, further comprising a second selection unit configured to select the first size or the second size,
wherein the plurality of size groups further includes a third size group including all sizes included in the first and second size groups, and
wherein, in a case where the third size group is selected by the first selection unit, and a candidate of a sheet size detected by the detection unit includes the first size and the second size, the determination unit determines a sheet size based on a selection result of the second selection unit.

3. The information processing apparatus according to claim 1, wherein the first selection unit selects any of the plurality of size groups based on an instruction issued by a user on a display unit of the information processing apparatus.

4. The information processing apparatus according to claim 1, wherein, in a case where information regarding a utilization site that has been acquired by the acquisition unit is information regarding the first site, the first size group is displayed as an initial value of a size group that is to be displayed on the display unit.

5. The information processing apparatus according to claim 1, wherein, in a case where the determination unit does not determine a sheet size to be a specific sheet size, a screen for notifying a user of a possibility that a position of a guide regulating a sheet is inappropriate is displayed on a display unit of the information processing apparatus.

6. The information processing apparatus according to claim 1, wherein, in a case where the selection result is the first size group, and a candidate of a sheet size detected by the detection unit includes the first size and the second size, the determination unit determines a sheet size to be the second sheet size.

7. The information processing apparatus according to claim 1, wherein the first sheet size is India legal and the second sheet size is legal.

8. The information processing apparatus according to claim 1, wherein the first size group is a size group including a sheet size of an A-series size and a sheet size of a B-series size, and the second size group is a size group including a sheet size of an inch size.

9. The information processing apparatus according to claim 1, wherein information regarding a utilization site of the information processing apparatus is information regarding a destination of the information processing apparatus.

10. The information processing apparatus according to claim 1, wherein in a case where the number of candidates of a sheet size detected by the detection unit is one, the determination unit determines a candidate detected by the detection unit, to be a sheet size.

11. The information processing apparatus according to claim 1, wherein the predetermined processing is processing of performing recording on a sheet.

12. The information processing apparatus according to claim 1, wherein the first site is India and the second site is Japan.

13. A control method for an information processing apparatus configured to execute predetermined processing on a sheet with a first size or a second sheet with a second size different from the first size, the method comprising:
acquiring information regarding a utilization site of the information processing apparatus;
selecting any of a plurality of size groups including a first size group including the first size, and a second size group including the second size;
detecting a candidate of a size of a sheet on which the predetermined processing is to be executed;
determining, based on a selection result obtained and a candidate of a sheet size detected, a size of a sheet on which the predetermined processing is to be executed; and
executing the predetermined processing based on the determined size of the sheet,
wherein, in a case where the selection result is the first size group and a candidate of a sheet size detected includes the first size and the second size, it is determined, based on information regarding a utilization site that has been acquired, being information regarding a first site, a sheet size to be the first sheet size, and
wherein based on information regarding a utilization site that has been acquired, being information regarding a second site different from the first site, a sheet size to be a specific sheet size is not determined.

14. A non-transitory computer-readable storage medium storing executable instructions, which when executed by one or more processors of an information processing apparatus, cause a computer to execute a control method of an information processing apparatus configured to execute predetermined processing on a sheet with a first size or a second sheet with a second size different from the first size, the control method comprising:
acquiring information regarding a utilization site of the information processing apparatus;
selecting any of a plurality of size groups including a first size group including the first size, and a second size group including the second size;
detecting a candidate of a size of a sheet on which the predetermined processing is to be executed;
determining, based on a selection result obtained and a candidate of a sheet size detected, a size of a sheet on which the predetermined processing is to be executed; and
executing the predetermined processing based on the determined size of the sheet,
wherein, in a case where the selection result is the first size group and a candidate of a sheet size detected includes the first size and the second size, it is determined, based on information regarding a utilization site that has been acquired, being information regarding a first site, a sheet size to be the first sheet size, and
wherein based on information regarding a utilization site that has been acquired, being information regarding a second site different from the first site, a sheet size to be a specific sheet size is not determined.
